(19) United States
(12) Patent Application Publication
(10) Pub. No.: US 2017/0188723 A1
(43) Pub. Date: Jul. 6, 2017

(54) SWEEP DETECTING HANGER

(71) Applicant: Adam Mark Will, Indianland, SC (US)

(72) Inventor: Adam Mark Will, Indianland, SC (US)

(21) Appl. No.: 14/983,808

(22) Filed: Dec. 30, 2015

(51) Int. Cl. A47F 5/08; G06Q 20/20; A47F 5/00; G06Q 10/08

(52) U.S. Cl. CPC A47F 5/0861; G06Q 10/087; G06Q 20/20; A47F 5/00

(57) ABSTRACT

A security device may include a body portion and a gate assembly. The body portion is disposed between two substantially parallel, longitudinally extending support members of a peg hook. The gate assembly is operably coupled to the body portion to rotate about an axis of rotation that is substantially perpendicular to a direction of extension of the support members. The gate assembly includes a first gate portion and a second gate portion. The gate assembly has a rest state in which the first gate portion extends substantially in a plane in which the support members lie and the second gate portion extends out of the plane such that movement of a product supported by the peg hook along the support members toward a distal end of the peg hook causes the product to rotate the gate assembly to an extraction position in which the second gate portion is substantially in the plane and the first gate portion is rotated out of the plane.

### TECHNICAL FIELD

Various example embodiments relate generally to retail theft deterrent and merchandise protection devices, and more particularly relate to methods and devices for inhibiting product sweeps and detecting such activity.

### BACKGROUND

Security devices have continued to evolve over time to improve the functional capabilities and reduce the cost of such devices. Some security devices are currently provided to be attached to individual products or objects in order to deter or prevent theft of such products or objects. However, because there is a cost associated with such security devices, they may not be suitable for protecting smaller or lower value products. Additionally, the packaging and display methods of some products may be such that certain security mechanisms or devices are unsuited to protection of certain products. Accordingly, other solutions may be desired to provide protection of such devices.

In some cases, products of best presented for display on a hanger (e.g., a peg hook) that is affixed to peg board. These types of displays give the retailer a great deal of flexibility to move the peg hooks around to optimize product display for the space available. Peg hooks can easily be moved around the peg board to provide the desired space between products or the pattern of display that is preferred.

In such a context, plastic packaging is typically provided with a slot at a top portion of the packaging and the slot is used to hang the product on the peg hook. Depending on the width of the product/packaging, a number of products may be slid onto the peg hook for display. Customers or store personnel are expected to remove products by sliding the product off the peg hook and the nature of the display generally stays the same until all of the products on a particular peg hook have been removed. The hole left in the display after all products have been removed provides an easily identifiable indication to the store personnel that inventor replenishment is needed. Thus, this display method provides a number of advantages, and is generally very popular.

However, this display method is susceptible to a particular theft practice known as a “sweep.” During a sweep, a thief will generally pass by a peg hook and take a large quantity of the products off the peg hook at the same time, thereby sweeping the products off the peg hook in a single motion. Furthermore, the hole left in the display when products have been removed can also be viewed as undesirable, since it can be unsightly or at least leaves a period of time where potential sales opportunities are lost before product replenishment occurs. Thus, there are also disadvantages to this display method.

### BRIEF SUMMARY OF SOME EXAMPLES

Some example embodiments may provide for an improved hanger design that can avoid or mitigate the disadvantages of the display method described above, while preserving the advantages. In this regard, some example embodiments may inhibit sweeps, and may even enable inventory management functions to be performed in some cases.

In one example embodiment, a security device is provided. The security device may include a body portion and a gate assembly. The body portion is disposed between two substantially parallel, longitudinally extending support members of a peg hook. The gate assembly is operably coupled to the body portion to rotate about an axis of rotation that is substantially perpendicular to a direction of extension of the support members. The gate assembly includes a first gate portion and a second gate portion. The gate assembly has a rest state in which the first gate portion extends substantially in a plane in which the support members lie and the second gate portion extends out of the plane such that movement of a product supported by the peg hook along the support members toward a distal end of the peg hook causes the product to rotate the gate assembly to an extraction position in which the second gate portion is substantially in the plane and the first gate portion is rotated out of the plane.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a peg hook or hanger;

FIG. 2, which includes FIGS. 2A and 2B, illustrates a security device including a control assembly according to an example embodiment;

FIG. 3 illustrates a perspective view of the security device of FIG. 2 with a product provided thereon in accordance with an example embodiment;

FIG. 4, which includes FIGS. 4A, 4B, 4C and 4D, illustrates a product in various positions while being removed from the peg hook during operation of the security device in accordance with an example embodiment; and

FIG. 5 illustrates a block diagram of the control assembly in accordance with an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used in herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments may relate to improvement of a security device and a control assembly for such a device. The improved security device of some example embodiments may inhibit sweeps by employing a gate assembly that is configured to limit the passage of product past a predetermined point on the peg hook at which the gate assembly is located. Although not required, some example embodiments may further employ a control assembly that enables numerous other functions to be integrated with or otherwise provided by the security device.

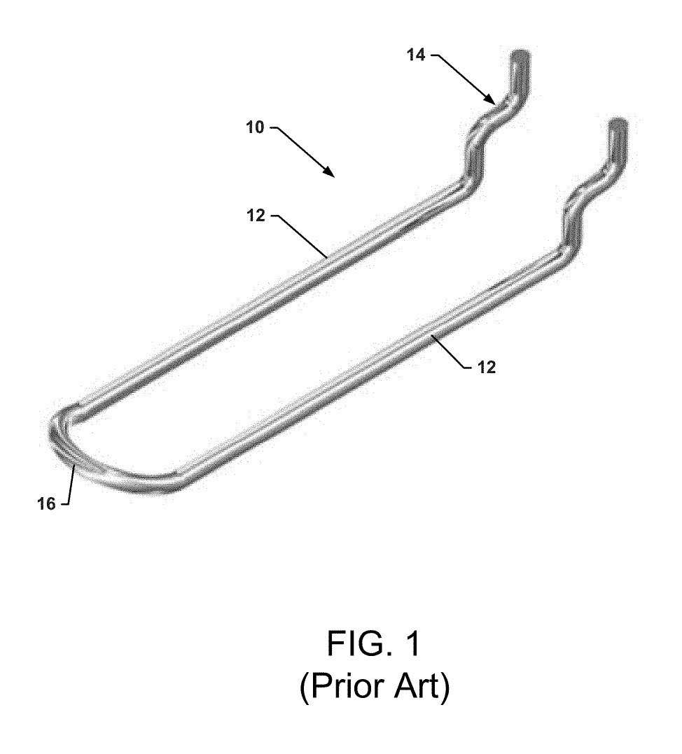

FIG. 1 illustrates a perspective view of a peg hook 10 or hanger that is often conventionally used for displaying products. As shown in FIG. 1, the peg hook 10 may include two longitudinally extending support members 12 that extend parallel to each other. The support members 12 may extend away from an attachment assembly 14 which is located at a distal end of the peg hook 10 relative to the peg board to which the peg hook 10 is attachable. The attachment assembly 14 may include a series of bends of the support members 12 to enable a portion of the attachment assembly 14 to be inserted into holes of the peg board so that one portion of the attachment assembly 14 lies proximate to a rear side of the peg board while another portion of the attachment assembly 14 lies proximate to a front side of the peg board (i.e., the side that is visible along with products on display).

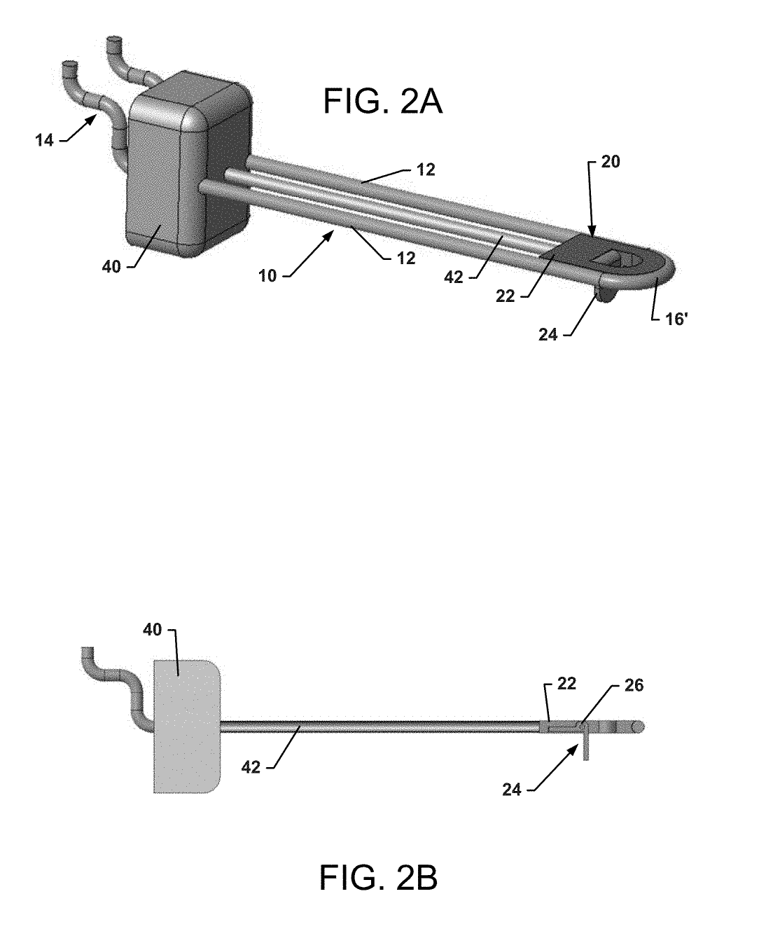

Although not required, the distal ends of the support members 12 may be connected to each other at a lip portion 16. The lip portion 16 may be upwardly turned to prevent products from slipping or easily being slid off the support members 12. In some cases, each of the support members 12 may include separate (e.g., unconnected) lip portions, and the support members 12 may be connected to each other at some other portion thereof. Moreover, in some cases, the lip portion 16 may not be upwardly turned. In this regard, the upward turning of the lip portion 16 of FIG. 1 may provide some small impediment to performance of a sweep. However, example embodiments may further inhibit the ability of a thief to perform a sweep of products on the peg hook 10, so the lip portion 16 may not need to be upwardly turned, as shown in FIGS. 2-4.

As shown in FIG. 2, a security device 20 of an example embodiment may be provided proximate to the distal end (e.g., near a flattened lip portion 16′) of the peg hook 10. Although the security device 20 could technically be provided at any portion of the peg hook 10, placement of the security device 20 proximate to the distal end of the peg hook 10 allows a maximum amount of space to be employed for the provision of products on the peg hook 10. The security device 20 may include a body portion 22 and a gate assembly 24. The body portion 22 may be formed of plastic or another rigid material that is formed to be substantially planar and lie in a same plane as the support members 12. In some cases, the body portion 22 may fit at the distal end of the support members 12, and lie in between the support members 12 while in contact with the lip portion 16′. Thus, three peripheral edges (or sides) of the body portion 22 may be contacted by the support members 12. However, it is possible that only two sides of the body portion 22 may be supported in some embodiments.

In some embodiments, the top and bottom flat or planar surfaces of the body portion 22 may be substantially similar in size, and a middle portion between the top and bottom flat or planar surfaces may have a smaller periphery than the peripheral edges of each of the top and bottom flat or planar surfaces. Thus, for example, the body portion 22 may be slid between the support members 12 from the proximal end thereof to the distal end of the support members 12 to substantially affix the body portion 22 to the peg hook 10.

In an example embodiment, the gate assembly 24 may be pivotally mounted to the body portion 22. Thus, for example, the gate assembly 24 may be operably coupled to the body portion 22 in a manner that allows the gate assembly 24 to rotate about an axis of rotation 26 that is defined at the body portion 22. The axis of rotation 26 may be substantially perpendicular to the direction of extension of the support members 12. The gate assembly 24 may rotate about the axis of rotation 26 responsive to contact with a product that was supported on the peg hook 10 as the product moves to the distal end of the support members 12 (e.g., toward the lip portion 16′). Rotation of the gate assembly 24 may cause the gate assembly 24 to change state, and to present an impediment to the passage of any additional products past the gate assembly 24. Essentially, the gate assembly 24 may act as a metering device, or rate of removal limitation device, to prevent a sweep of products on the peg hook 10.

Referring still to FIG. 2, which includes a perspective view of the security device 20 and peg hook 10 in FIG. 2A and cross sectional view of the same in FIG. 2B, the security device 20 of some embodiments may further include and/or otherwise be operably coupled to a control assembly 40. The control assembly 40 may functionally interconnect with the security device 20 via wires that may be provided in a conduit 42. The conduit 42 of an example embodiment may be provided in between the support members 12 (and lie in a same plane therewith) to extend from the control assembly 40 to the security device 20. In an example embodiment, one or more communication wires may be provided in the conduit 42 to operably couple the control assembly 40 and the security device 20 for communication therebetween. However, in some cases, the security device 20 and control assembly 40 could wirelessly communicate with each other.

The control assembly 40 and conduit 42 are optional components that may be excluded from some embodiments, or may be added to others on a permanent or removable basis. Thus, for example, the control assembly 40 could be added to some peg hooks 10 and not others depending upon the products to be displayed thereon. The control assembly 40 can therefore be selectively mated to the security device 20 to enhance the capabilities of the security device 20 or may be removed therefrom to enable the security device 20 to operate in a stand alone mode. The control assembly 40 and the enhanced capabilities provided thereby will be discussed in greater detail below.

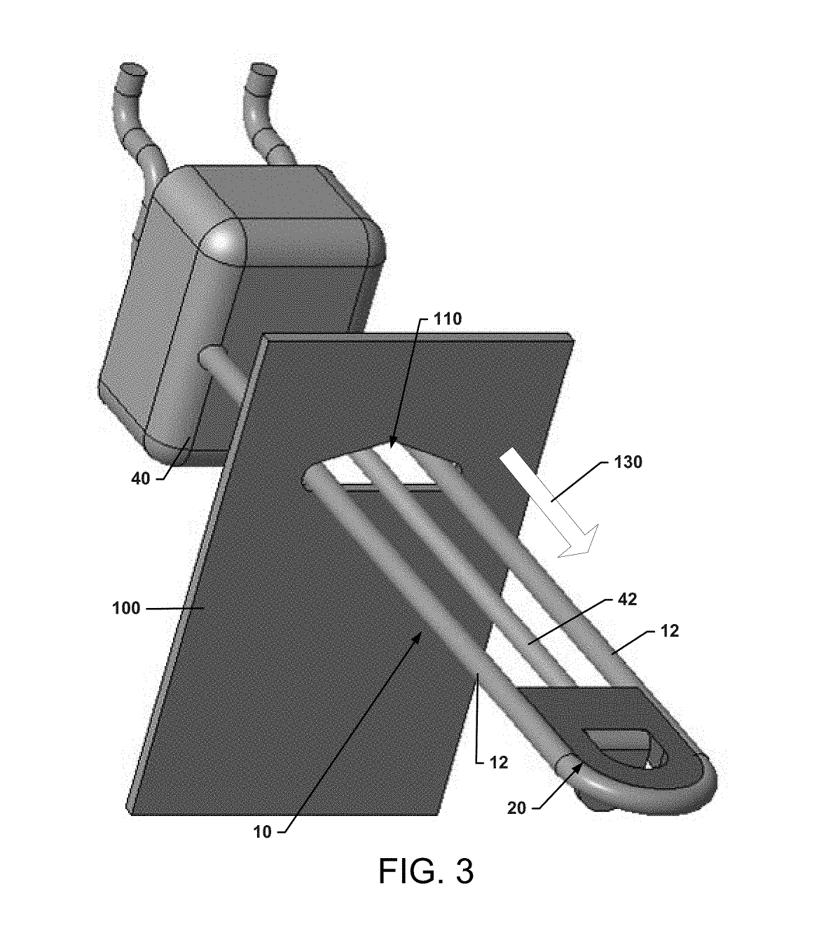

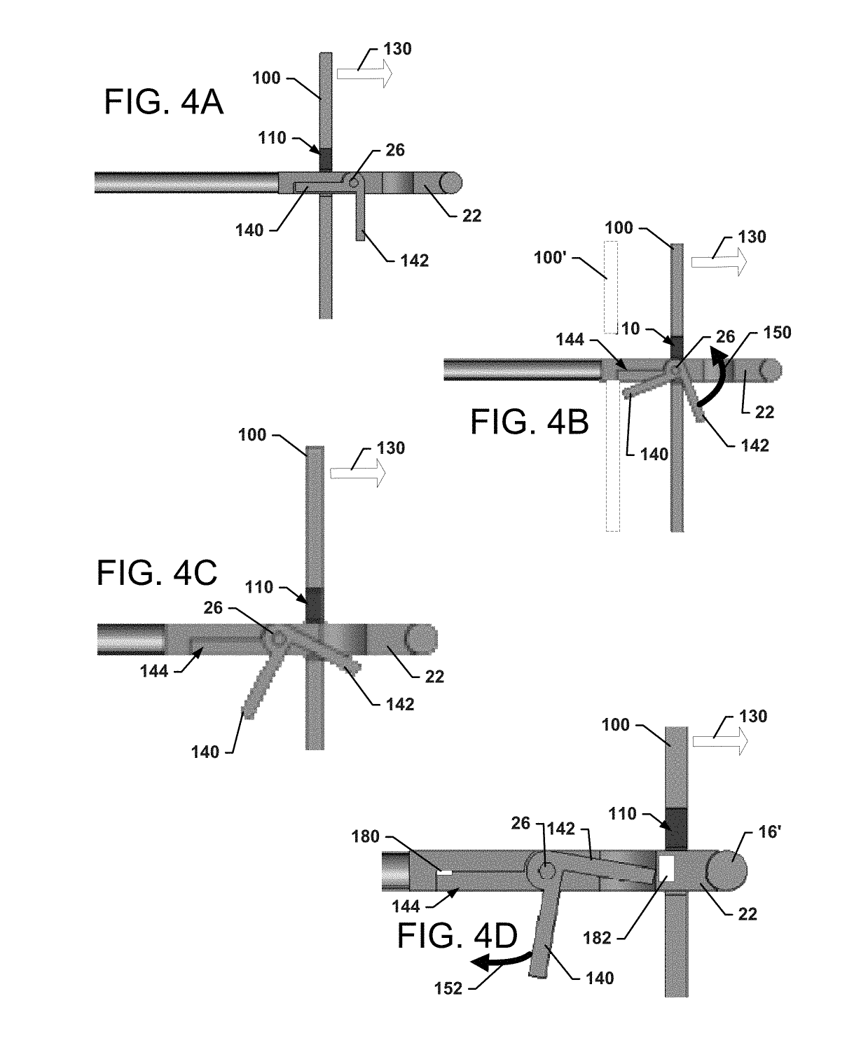

FIG. 3 illustrates a perspective view of the security device 20 of FIG. 2 with a product 100 provided thereon in accordance with an example embodiment. The product 100 may have a slot 110 provided at a top portion thereof, and a substantial portion of the product 100 may dangle below the slot 110 when the product 100 is supported on the peg hook 10. The product 100 may be a retail item or may be packaging for a retail item. The product 100 may moveable by sliding the slot 110 along the support members 12 of the peg hook 10. To remove the product 100 from the peg hook 10, the product 100 may be moved toward the distal end of the support members 12 and past the security device 20 in the direction shown by arrow 130. Movement of the product 100 into contact with the security device 20 may cause the security device 20 to shift from a rest state (which is shown in FIG. 3) to an extraction position which allows the product to pass the gate assembly 24, while the gate assembly 24 simultaneously blocks passage of additional products that may follow the product 100 in the direction of arrow 130. The transition between the rest state and the extraction position is shown in FIG. 4 and further explained in reference to FIG. 4.

FIG. 4, which includes FIGS. 4A, 4B, 4C and 4D, illustrates the product 100 in various positions while being removed from the peg hook 10 during operation of the security device 20 (and more particularly operation of the gate assembly 24) in accordance with an example embodiment. In this regard, FIG. 4A shows the gate assembly 24 in the rest state. In the rest state, a first portion of the gate assembly 24 (e.g., first gate portion 140) is substantially coplanar with the support members 12 and/or with the body portion 22. The first gate portion 140 may therefore be a substantially flat member that is unsupported at a distal end and supported proximate to the axis of rotation 26 at a proximal end. A second gate portion 142 of the gate assembly 24 may also be a substantially flat member that is unsupported at a distal end and supported proximate to the axis of rotation 26 at a proximal end thereof. It should be appreciated that although both the first gate portion 140 and the second gate portion 142 terminate and/or intersect proximate to the axis of rotation 26, such intersection and/or termination may be spaced apart from the axis of rotation 26 in some cases.

In the rest state, the second gate portion 142 may extend out of the plane in which the support members 12, the first gate portion 140 and/or the body portion 22 lie. Moreover, in some cases, the first gate portion 140 and the second gate portion 142 may be substantially perpendicular to each other. Based on this configuration, it can be appreciated that movement of the gate assembly 24 out of the rest state involves rotation of the gate assembly 24 about the axis of rotation 26 to move the first gate portion 140 out of the plane in which the support members 12 lie. Furthermore, it can be appreciated that movement of the second gate portion 142 out of a position in which the second gate portion 142 is substantially perpendicular to the plane in which the support members 12 lie will necessarily pull the first gate portion 140 out of the plane in which the support members 12 lie and thereby also out of the rest state.

Referring to FIG. 4A, while the gate assembly 24 is in the rest state, the product 100 (and the slot 110) may be enabled to pass over both the body portion 22 and the first gate portion 140 of the gate assembly 24. In some cases, the position of FIG. 4A may be achieved without any contact between the product 100 and any portion of the gate assembly 24. This may be accomplished due to the gate assembly 24 (and more specifically the first gate portion 140) fitting within a recess 144 formed in a bottom surface of the body portion 22 as shown in FIG. 4A. The recess 144 is visible in FIGS. 4B, 4C and 4D, as the first gate portion 140 vacates the recess 144. In some cases, the first gate portion 140 may lie substantially flush with a bottom surface of the body portion 22 when the first gate portion 140 is in the rest state.

Approximately when a plane in which the slot 110 lies intersects the axis of rotation 26, the product 100 may contact the second gate portion 142 to begin to move the second gate portion 142 out of the rest state, as shown in FIG. 4B. Movement of the second gate portion 142 out of the rest state pulls the first gate portion 140 out of contact with the body portion 22 of the security device 20 and out of the rest state as the gate assembly 24 rotates about the axis of rotation 26 in the direction of arrow 150. The first gate portion 140 exits the recess 144 and moves to a position that would block any subsequent product (e.g., as shown in dashed lines as next product 100′). Thus, when the first gate portion 140 moves out of the rest state, the first gate portion 140 moves into a blocking position that blocks passage of the next product 100′.

The second gate portion 142 is then carried by the product 100 as the product 100 continues to move in the direction of arrow 130 as shown in FIG. 4C. The first gate portion 140 and the second gate portion 142 have portions thereof on both sides of the product 100 in a transition region shown in FIGS. 4B and 4C. During this time, the first gate portion 140 continues to be in the blocking position, but the product 100 continues to move in the direction of arrow 130 while the gate assembly 24 rotates in the direction of arrow 150.

Finally, as the product 100 passes to a last point at which the second gate portion 142 is carried by the product 100, the gate assembly 24 has transitioned to an extraction position where the positions of the first and second gate portions 140 and 142 have substantially alternated. In this regard, the first gate portion 140 was substantially in a plane as the support members 12 and the second gate portion 142 was substantially perpendicular to the plane in the rest state. However, the first gate portion 140 is substantially perpendicular to the plane in which the support members 12 lie and the second gate portion 140 is substantially in the plane in the extraction position. In the extraction position, the product is nearly beyond the gate assembly 24 (e.g., nearly beyond a point at which contact with the second gate portion 142 is possible), and the product is free to pass off the distal end of the peg hook 10 as shown in FIG. 4D. Meanwhile, the first gate portion 140 remains in the blocking position also in the extraction position. The gate assembly 24 is free to rotate back to the rest state after the product 100 no longer contacts the second gate portion 142 by rotating about the axis or rotation 26 in the direction of arrow 152. Of note, the second gate portion 142 need not be fully parallel to the top surface of the body portion 22 to lie substantially in the plane of the support members 12 as shown in FIG. 4D. In this regard, the second gate portion 142 may be nearly entirely (or entirely) within the top and bottom boundaries of the body portion 22.

In some example embodiments, the gate assembly 24 may be biased toward the rest state. Thus, for example, a spring (e.g., a leaf spring or coil spring) may be used to bias the gate assembly 24 toward the rest state. However, in some embodiments, the biasing may be accomplished without a spring. For example, the second gate portion 142 may be heavier than the first gate portion 140 so that gravity naturally tends to draw the second gate portion 142 to the rest state. The arrangement shown in FIGS. 2-4 (i.e., where the second gate portion 142 extends downward) may be employed when if the second gate portion 142 is heavier than the first gate portion 140, but it may also be reversed in some cases. Thus, for example, the first gate portion 140 could be heavier than the second gate portion 142 and the second gate portion 142 could extend upward instead of downward. The upward extending second gate portion 142 configuration could also be employed with springs performing the biasing.

As the first gate portion 140 rotates out of the rest state and to the extraction position, the first gate portion 140 is in the blocking position to block the next product 100′ during substantially the entire transition. Meanwhile, the second gate portion 142 is carried by the product 100 throughout the transition to the extraction position from the rest state to allow the product 100 to clear the gate assembly 24 and to move the second gate portion 142 until it lies substantially in (e.g., is in the plane or within 10 degrees or so of the plane in which the body portion 22 and/or the support members 12 lie.

The basic configuration of the security device 20 (i.e., without the control assembly 40) can therefore prevent sweeps by ensuring that the next product 100′ is blocked by the act of removing the product 100. Of note, if the products are thin enough, it may be possible to remove more than one product at a time by moving multiple products over the first gate portion 140 and into contact with the second gate portion 142. However, the width of products and the spacing between such products relative to the length of the first gate portion 140 determines a physical limit on how many products could be removed at one time. The length of the first gate portion 140 may therefore be selected to be long enough to ensure that rotation of the first gate portion 140 provides a block to the next product 100′, but short enough to limit the number of products that can be placed over the first gate portion 140 prior to transitioning to the extraction position shown in FIG. 4D. The length of the first and second gate portions 140 and 142 may therefore be equal or different.

As mentioned above, the security device 20 may include or otherwise interface with the control assembly 40 to enhance the functionality of the security device 20 in some cases. The control assembly 40 may include a housing that houses various electronic components configured to receive information from the gate assembly 24 (or about gate assembly 24 position) via the conduit 42. In some embodiments, a position of the gate assembly 24 (e.g., in the rest state or in the extraction position) may be determined using a sensor assembly that is operably coupled to the control assembly 40 (e.g., via the conduit 42). The sensor assembly may include one or more sensors (e.g., sensor 180 and sensor 182) that may detect respective ones of such positions. For example, sensor 180 may be a simple plunger that is deflected when the first gate portion 140 is housed in the recess 144 such that the gate assembly 24 is in the rest state. Alternatively, the sensor 180 may be a Hall effect sensor configured to detect the presence (or absence) of the first gate portion 140. Sensor 182 be provided at a portion of the body portion 22 which is proximate to an end (or other part) of the second gate portion 142 when the gate assembly 24 is in the extraction position. Sensor 182 could alternatively be provided (or have portions thereof provided) in the distal end of the second gate portion 142. In either case, the sensor 182 may detect the presence (or absence) of the second gate portion 142. Again, the second sensor 182 may be provided using a simple plunger assembly, a Hall effect sensor, or any other suitable sensing mechanism.

The sensor assembly may therefore provide an indication of when the gate assembly 24 is in the rest state and when the gate assembly 24 is in the extraction position. It may also be determinable that the gate assembly 24 is transitioning between such states when the gate assembly 24 is neither in the rest state nor the extraction position. Alternatively, the sensor assembly may merely be configured to determine only one of the rest state or the extraction position. In any case, the indication of current state, or a state change, may be tracked and counted. Thus, for example, each transition from the rest state to the extraction state and/or the fact of leaving the rest state or detecting the extraction state may be counted by the control assembly 40. The control assembly 40 may therefore essentially be capable of determining how many products have been removed based on the number of state changes detected. In some example embodiments, the control assembly 40 may be further configured to determine a time period between transitions (or transition events) detected by the sensor assembly. The time between transitions could be compared to a threshold to determine whether to issue an alert for rapid transitions. The alert may provide an alarm or otherwise simply notify store personnel about the event.

In some cases, detection of the transition may trigger a timer to count until a product corresponding to the product 100 is purchased at a point of sale. Thus, for example, if a high value item is removed from the peg hook 10, the store personnel may be alerted if the item is not actually purchased at the point of sale within a predetermined period of time. The length of the predetermined period of time may be set based on the value of the item. In some cases, the control assembly 40 may also include a sensor to detect movement (or removal) of the peg hook 10 itself.

In an example embodiment, the security device 20 and/or the control assembly 40 may generally operate in an unload mode (or extraction mode) where all transitions are assumed to be associated with product removal. In the unload mode, every transition may be assumed to decrement an inventory count by one unit. However, in some cases, the security device 20 and/or the control assembly 40 may also be capable of operating in a load mode in which inventory count may be incremented instead of decremented. Thus, for example, while the load mode is activated, the second gate portion 142 may be manually drawn into the extraction position so that the product 100 can be slid over the second gate portion 142 and then the product 100 can carry the first gate portion 140 to the rest position through a rotation opposite that of arrow 150 of FIG. 4B to place the product on the peg hook 10 between the gate assembly 24 and the control assembly 40. Counting transitions in the load mode may increase inventory count by one unit so that, by shifting between load and unload mode, an active inventory count may be maintained by the control assembly 40.

In an example embodiment, a switch on the control assembly 40 could be operated to alternate between the load and unload modes. However, in other cases, a remote instruction could wirelessly be provided to the control assembly 40. Alternatively or additionally, a key (e.g., electronic, physical, magnetic, or the like) may be required to enable the control assembly 40 to be shifted between modes. Programming of the control assembly 40 may be handled via a local or remote user interface. Thus, the control assembly 40 may include electronic components that are configurable to control the functionality of the control assembly 40.

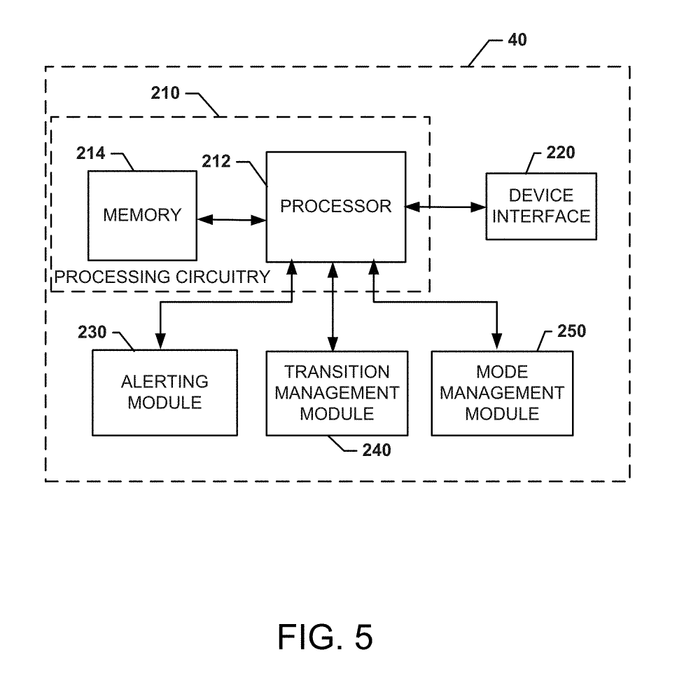

FIG. 5 illustrates a block diagram of the control assembly 40 in accordance with an example embodiment. As shown in FIG. 5, the control assembly 40 may include processing circuitry 210 configured in accordance with an example embodiment as described herein. In this regard, for example, the control assembly 40 may utilize the processing circuitry 210 to provide electronic control inputs to one or more functional units (which may be implemented by or with the assistance of the of the processing circuitry 210) of the control assembly 40 to receive, transmit and/or process data associated with the one or more functional units and perform communications necessary to enable counting of transitions, mode control, and implementation of alerts or other activities based on the counting of transitions or based on temporal factors associated with various transitions as described herein.

In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment on a single chip or as a single “system on a chip.” As such, in some cases, a chip or chipset may constitute means for performing one or more operations for providing the functionalities described herein. The processing circuitry 210 may further be operably coupled to a device interface 220 that may be configured to enable the control module 40 to be operably coupled to external devices via wired, wireless or physical connections.

In an example embodiment, the processing circuitry 210 may include one or more instances of a processor 212 and memory 214. As such, the processing circuitry 210 may be embodied as a circuit chip (e.g., an integrated circuit chip) configured (e.g., with hardware, software or a combination of hardware and software) to perform operations described herein. The processing circuitry 210 may interface with and/or control the operation of various other components of the control assembly 40 including, for example, an alerting module 230, a transition management module 240 and a mode management module 250.

In an example embodiment, the processor 212 (or the processing circuitry 210) may be embodied as, include or otherwise control the alerting module 230, the transition management module 240 and the mode management module 250 (or components thereof). As such, in some embodiments, the processor 212 (or the processing circuitry 210) may be said to cause each of the operations described in connection with the alerting module 230, the transition management module 240 and the mode management module 250 (or components thereof) by directing the alerting module 230, the transition management module 240 and the mode management module 250 (or respective components) to undertake the corresponding functionalities responsive to execution of instructions or algorithms configuring the processor 212 (or processing circuitry 210) accordingly.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to example embodiments while configured accordingly. Thus, for example, when the processor 212 is embodied as an ASIC, FPGA or the like, the processor 222 may be specifically configured hardware for conducting the operations described herein. Alternatively, as another example, when the processor 212 is embodied as an executor of software instructions, the instructions may specifically configure the processor 212 to perform the operations described herein. In some cases, the processor 212 may be embodied as a single entity, or may be distributed amongst other entities (e.g., such that processors of or associated with multiple components including the alerting module 230, the transition management module 240 and the mode management module 250, or another entity cooperate with each other to perform various functions).

In an example embodiment, the memory 214 may include one or more non-transitory memory devices such as, for example, volatile and/or non-volatile memory that may be either fixed or removable. The memory 214 may be configured to store information, data, applications, instructions or the like for enabling the alerting module 230, the transition management module 240 and the mode management module 250 to carry out various functions in accordance with example embodiments.

The alerting module 230 may include an audio device (e.g., a piezoelectric, mechanical, or electromechanical beeper, buzzer, or other audio signaling device such as an audible alarm), or may wirelessly communicate with such an audio device. The alerting module 230 may include a speaker or other sound generating device. In some example embodiments, the alerting module 230 may also or alternatively include visible indicia (e.g., lights of one or more colors such as a bi-color (e.g., red/green) LED). The visible indicia of the alerting module 230 and/or the audio device thereof may be used in various ways to facilitate notification of the occurrence of any of a number of predefined alert triggers. The predefined alert triggers may be associated with the occurrence of transitions, the rate of transitions, temporal factors associated with transitions, and/or the like.

The transition management module 240 may (dependent on the mode) detect transitions and take any of a number of programmed actions based on such transitions. Thus, for example, the transition management module 240 may be configured to count transitions to manage inventory counts based on the number of transitions (again dependent upon mode). Thus, for example, if the inventory count is decremented to zero, an out of stock condition may be present, and the transition management module 240 may inform the alerting module 230 to generate an out of stock message to an operator. The transition management module 240 may also or alternatively monitor the time between transitions to compare such time to a threshold and/or to calculate an average rate of transition that may be compared to a rate threshold. In some cases, the transition management module 240 may communicate with external equipment (e.g., point of sale terminals or other external computing devices) to determine whether a sale is completed for the product 100 within a predetermined amount of time after the product 100 is removed from the peg hook 10 based on a time measured after the transition. Other programmable functions may also or alternatively be performed in other cases.

The mode management module 250 may be configured to shift the control module 40 between the load and unload modes. Thus, the mode management module 250 may directly interface with the transition management module 240 so that the transition management module 240 treats the transitions detected appropriately for the current mode.

As can be appreciated from the descriptions above, a security device of an example embodiment may include a body portion and a gate assembly. The body portion is disposed or otherwise supportable substantially between two substantially parallel, longitudinally extending support members of a peg hook. The gate assembly is operably coupled to the body portion to rotate about an axis of rotation that is substantially perpendicular to a direction of extension of the support members. The gate assembly includes a first gate portion and a second gate portion. The gate assembly has a rest state in which the first gate portion extends substantially in a plane in which the support members lie and the second gate portion extends out of the plane such that movement of a product supported by the peg hook along the support members toward a distal end of the peg hook causes the product to rotate the gate assembly to an extraction position in which the second gate portion is substantially in the plane and the first gate portion is rotated out of the plane.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, in some cases, rotation of the gate assembly from the rest state to the extraction position responsive to movement of the product toward the distal end of the peg hook causes the first gate portion to block movement of a next product past the gate assembly moving toward the distal end of the peg hook. Alternatively or additionally, the first and second gate portions may be substantially perpendicular to each other. Alternatively or additionally, the gate assembly may be biased toward the rest state. In various examples, gravity or a spring biases the gate assembly toward the rest state. Alternatively or additionally, the first gate portion may extend from the axis of rotation away from the distal end of the peg hook in the rest state and the second gate portion extends downward. Alternatively or additionally, the body portion and the first gate portion overlap when the gate assembly is in the rest state. Alternatively or additionally, a sensor assembly may be provided at a portion of the body portion to detect when the first gate portion is in the rest state. Alternatively or additionally, a sensor assembly may be provided at a portion of the body portion to detect when the second gate portion is in the extraction position. Alternatively or additionally, a sensor assembly may be provided at a portion of the body portion to detect a transition between the rest state and the extraction position. In some cases, the security device may further include a control assembly including processing circuitry operably coupled to the sensor assembly to receive information indicative of a position of the gate assembly. Alternatively or additionally, the processing circuitry may be configured to count transitions of the gate assembly. Alternatively or additionally, the processing circuitry may be configured to communicate an out of stock message based on the transitions counted. Alternatively or additionally, the processing circuitry may be configured to determine a time between transitions to determine a rate of removal. Alternatively or additionally, the processing circuitry may be configured to determine a failure to execute a sales transaction at a point of sale within a predetermined time after detection of a transition event. Alternatively or additionally, the processing circuitry may be configured to determine that the peg hook has been removed from peg board at which the peg hook was supported. Alternatively or additionally, the processing circuitry may be configured to transition between a load mode and an unload mode. In such an example, transitions counted may decrease an inventory count in the unload mode and increase inventory count in the load mode. Alternatively or additionally, a key may be required to shift between the load mode and the unload mode. Alternatively or additionally, the body portion may be in contact with the peg hook on at least three peripheral edges of the body portion.

Example embodiments may provide a security system that can effectively protect a product to which a security tag is attached from theft, by providing an automatically tunable detection device that minimizes false alarms and maximizes detection capabilities. By enabling the security device to be detected more effectively and with fewer false alarms, effectiveness may be increased while overall satisfaction of a retailer using instances of the security device to protect products may be improved.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A security device comprising:
a body portion, the body portion being disposed between two substantially parallel, longitudinally extending support members of a peg hook; and
a gate assembly operably coupled to the body portion to rotate about an axis of rotation that is substantially perpendicular to a direction of extension of the support members,
wherein the gate assembly comprises a first gate portion and a second gate portion, the gate assembly having a rest state in which the first gate portion extends substantially in a plane in which the support members lie and the second gate portion extends out of the plane such that movement of a product supported by the peg hook along the support members toward a distal end of the peg hook causes the product to rotate the gate assembly to an extraction position in which the second gate portion is substantially in the plane and the first gate portion is rotated out of the plane.

2. The security device of claim 1, wherein rotation of the gate assembly from the rest state to the extraction position responsive to movement of the product toward the distal end of the peg hook causes the first gate portion to block movement of a next product past the gate assembly moving toward the distal end of the peg hook.

3. The security device of claim 1, wherein the first and second gate portions are substantially perpendicular to each other.

4. The security device of claim 1, wherein the gate assembly is biased toward the rest state.

5. The security device of claim 4, wherein gravity biases the gate assembly toward the rest state.

6. The security device of claim 4, wherein a spring biases the gate assembly toward the rest state.

7. The security device of claim 1, wherein the first gate portion extends from the axis of rotation away from the distal end of the peg hook in the rest state and the second gate portion extends downward.

8. The security device of claim 1, wherein the body portion and the first gate portion overlap when the gate assembly is in the rest state.

9. The security device of claim 1, wherein a sensor assembly is provided at a portion of the body portion to detect when the first gate portion is in the rest state.

10. The security device of claim 1, wherein a sensor assembly is provided at a portion of the body portion to detect when the second gate portion is in the extraction position.

11. The security device of claim 1, wherein a sensor assembly is provided at a portion of the body portion to detect a transition between the rest state and the extraction position.

12. The security device of claim 11, further comprising a control assembly comprising processing circuitry operably coupled to the sensor assembly to receive information indicative of a position of the gate assembly.

13. The security device of claim 12, wherein the processing circuitry is configured to count transitions of the gate assembly.

14. The security device of claim 13, wherein the processing circuitry is configured to communicate an out of stock message based on the transitions counted.

15. The security device of claim 13, wherein the processing circuitry is configured to determine a time between transitions to determine a rate of removal.

16. The security device of claim 12, wherein the processing circuitry is configured to determine a failure to execute a sales transaction at a point of sale within a predetermined time after detection of a transition event.

17. The security device of claim 12, wherein the processing circuitry is configured to determine that the peg hook has been removed from peg board at which the peg hook was supported.

18. The security device of claim 12, wherein the processing circuitry is configured to transition between a load mode and an unload mode, and wherein transitions counted decrease an inventory count in the unload mode and increase inventory count in the load mode.

19. The security device of claim 18, wherein a key is required to shift between the load mode and the unload mode.

20. The security device of claim 1, wherein the body portion is in contact with the peg hook on at least three peripheral edges of the body portion.
